(19) United States
(12) Patent Application Publication
(10) Pub. No.: US 2012/0331006 A1
(43) Pub. Date: Dec. 27, 2012

(54) DATA ACCESS METHOD AND DATA ACCESS DEVICE

(75) Inventors: Takeo Sakairi, Tokyo (JP); Takashi Tamada, Tokyo (JP); Yukio Goto, Tokyo (JP); Mitsuo Shimotani, Tokyo (JP); Makoto Mikuriya, Tokyo (JP)

(73) Assignee: MITSUBISHI ELECTRIC CORPORATION, Tokyo (JP)

(21) Appl. No.: 13/582,855

(22) PCT Filed: Apr. 16, 2010
(86) PCT No.: PCT/JP2010/002780

§ 371 Date: Sep. 5, 2012

(51) Int. Cl. G06F 17/30

(52) U.S. Cl. 707/781; 707/E17.001

(57) ABSTRACT

An information processing apparatus has data management data that determines storage locations of real data in a data group in accordance with data definition information indicating a data structure of the data group, and a data access program that describes an access function to the real data whose data structure is specified in accordance with the data definition information, and gains access to the real data of the data group by executing the data access program while determining the storage locations of the real data by referring to the data management data.

### TECHNICAL FIELD

The present invention relates to a data access method and data access device for acquiring desired data by gaining access to a database.

### BACKGROUND ART

For example, Patent Document 1 discloses a service function provider system which manages on a table addresses of service functional units for executing service functions and pointers to service function executing units, and executes a service function by acquiring, when making data access or calling a particular service function, the address corresponding to a pointer by referring to the table, and by starting a service function executing unit in accordance with the address. Referring to the table, the system can directly call a function linked to a parent program from a common library by using an entry name.

However, the Patent Document 1 contains no mention of relationships between a data access program that accesses real data and the management data of the addresses and pointers. Generally, when a data specification is altered, the data access program must be revised in accordance with it, and unless the data access program cannot cope with it, efficient data access cannot be achieved even if only changes of the addresses or offsets indicating storage locations of the data are managed.

In particular, as for the map data used by the navigation system in general, its volume has a variable length and is large, its update is made frequently, and its data format is changed often. In this case, every time the data specification is altered, data addresses or offsets based on a data specification after alteration and a data access program that accesses real data in accordance with them become necessary.

The present invention is implemented to solve the foregoing problems. Therefore it is an object of the present invention to provide a data access method and data access device capable of gaining access to desired data stored in a data group efficiently and quickly.

### PRIOR ART DOCUMENT

### Patent Document

Patent Document 1: Japanese Patent No. 3022837.

### DISCLOSURE OF THE INVENTION

According to a data access method in accordance with the present invention, an information processing apparatus, which comprises data management data that determines storage locations of real data in a data group in accordance with data definition information indicating a data structure of the data group storing the real data and a data access program that describes an access function to the real data whose data structure in the data group is specified in accordance with the data definition information, gains access to the real data of the data group by executing the data access program while determining the storage locations of the real data by referring to the data management data.

According to the present invention, the information processing apparatus, which comprises the data management data that determines storage locations of the real data in the data group in accordance with the data definition information indicating the data structure of the data group storing the real data and the data access program that describes the access function to the real data whose data structure in the data group is specified in accordance with the data definition information, gains access to the real data of the data group by executing the data access program while determining the storage locations of the real data by referring to the data management data. Accordingly, it offers an advantage of being able to access desired data stored in the data group efficiently and quickly.

### BRIEF DESCRIPTION OF THE DRAWINGS

FIG. 1 is a block diagram showing a configuration of a data access device of an embodiment 1 in accordance with the present invention;

FIG. 2 is a block diagram showing a hardware configuration of an information processing system to which a data access device in accordance with the present invention is applied;

FIG. 3 is a diagram showing an outline of a data aggregate constituting a database;

FIG. 4 is a flowchart showing a flow of the operation of the data access device of the embodiment 1;

FIG. 5 is a table showing an example of data definition information;

FIG. 6 is a diagram showing an outline of a data aggregate whose data structures are specified by the data definition information of FIG. 5;

FIG. 7 is a flowchart showing a flow of the generating processing of data management data by a data management data generating unit;

FIG. 8 is a table showing an example of a real data structure of a data aggregate;

FIG. 9 is a table showing another expression example of a real data structure of a data aggregate;

FIG. 10 is a diagram showing another expression example of a real data structure of a data aggregate;

FIG. 11 is a table showing an example of data management data;

FIG. 12 is a diagram showing data items necessary to execute a function A;

FIG. 13 is a diagram showing an example of data management data output definition information;

FIG. 14 is a table showing an example of data management data;

FIG. 15 is a diagram showing an outline of a usage pattern of data management data generated for each function;

FIG. 16 is a diagram showing an example of a data access program;

FIG. 17 is a diagram showing an example of data access program output definition information;

FIG. 18 is a diagram showing an outline of a usage pattern of the data management data and data access program generated for each function;

FIG. 19 is a block diagram showing a configuration of a navigation system of an embodiment 2 in accordance with the present invention;

FIG. 20 is an ER diagram defining a data structure of a polygon and point in the map DB of FIG. 19;

FIG. 21 is a diagram showing map graphic data formed according to the definition of FIG. 20;

FIG. 22 is a table showing the data management data for polygon graphics;

FIG. 23 is a table showing the data management data for point graphics;

FIG. 24 is a table showing the data management data for managing both polygon graphics and point graphic;

FIG. 25 is a block diagram showing another configuration of the navigation system of the embodiment 2;

FIG. 26 is a block diagram showing a configuration of a navigation system of an embodiment 3 in accordance with the present invention;

FIG. 27 is a block diagram showing a configuration of a navigation system of an embodiment 4 in accordance with the present invention;

FIG. 28 is a flowchart showing a flow of update processing of data definition information by the navigation system of the embodiment 4;

FIG. 29 is a flowchart showing a flow of update processing of the data management data by the navigation system of the embodiment 4;

FIG. 30 is a block diagram showing another configuration of a navigation system of an embodiment 5 in accordance with the present invention;

FIG. 31 is a flowchart showing a flow of update processing of the data definition information and data management data by the navigation system of the embodiment 5;

FIG. 32 is a table showing an example of update definition information;

FIG. 33 is a diagram showing an outline of update processing of the data definition information according to the update definition information of FIG. 32;

FIG. 34 is a block diagram showing a configuration of a navigation system of an embodiment 6 in accordance with the present invention; and

FIG. 35 is a block diagram showing another configuration of the navigation system of the embodiment 6.

### EMBODIMENTS FOR CARRYING OUT THE INVENTION

The best mode for carrying out the invention will now be described with reference to the accompanying drawings to explain the present invention in more detail.

### Embodiment 1

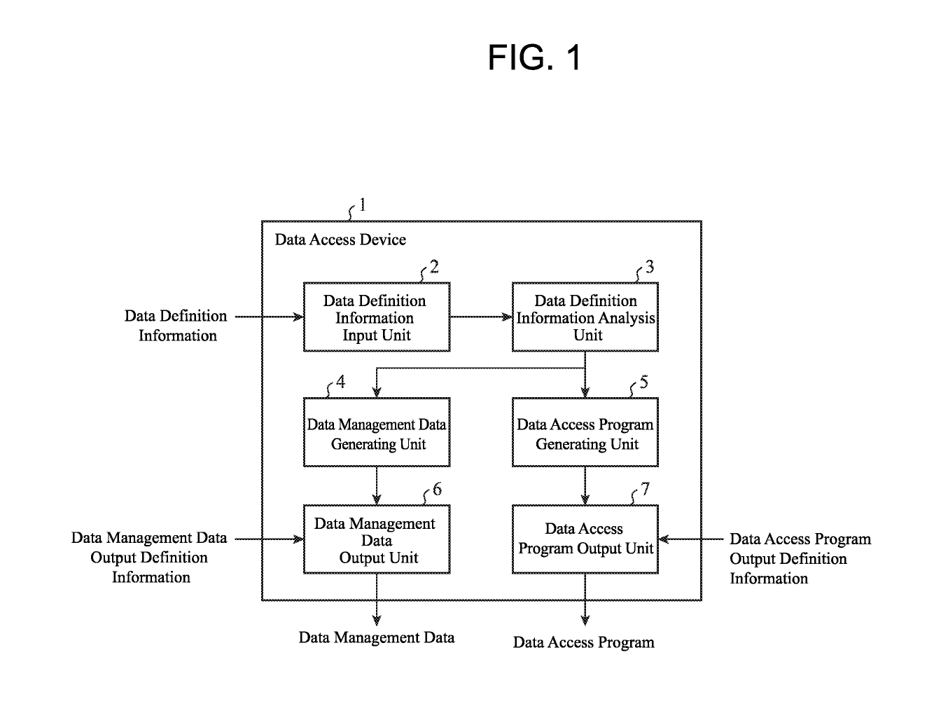

FIG. 1 is a block diagram showing a configuration of a data access device of an embodiment 1 in accordance with the present invention. In FIG. 1, the data access device 1 of the embodiment 1 is an apparatus for automatically generating data management data and a data access program.

The term “data management data” refers to data that sets, in an aggregate of data (a database or file system) (a data group) used by a system for achieving a certain objective, an address indicating a storage location of data or an offset indicating the top of data or a distance from the top of data to a particular component (data item) (a storage location in the data group). The term “data access program” refers to a program that accesses real data in the data aggregate by referring to the data management data.

The data access device 1 comprises a data definition information input unit 2, a data definition information analysis unit 3, a data management data generating unit 4, a data access program generating unit 5, a data management data output unit 6, and a data access program output unit 7.

The data definition information input unit 2, which is a component for receiving data definition information, reads the data definition information from an external storage unit, for example. The data definition information analysis unit 3 is a component for analyzing the data definition information. The data definition information is information that defines a data structure in the data aggregate to be accessed. For example, it defines data items and their data lengths constituting the data.

The data management data generating unit 4 is a component for generating the data management data according to an analysis result of the data definition information analysis unit 3. In addition, the data access program generating unit 5 is a component for generating a data access program according to an analysis result of the data definition information analysis unit 3. The data management data output unit 6 is a component for generating and outputting the data management data about items to be output from the data management data generated by the data management data generating unit 4 by referring to data management data output definition information. Here, the term “data management data output definition information” is information indicating the output format of the data management data about items to be output and a data item of the data to be output.

The data access program output unit 7 is a component for generating and outputting the data access program to be output from the data access program generated by the data access program generating unit 5 by referring to data access program output definition information. Here, the term “data access program output definition information” refers to information that designates an output language, output type, naming rule and the like of the data access program to be output.

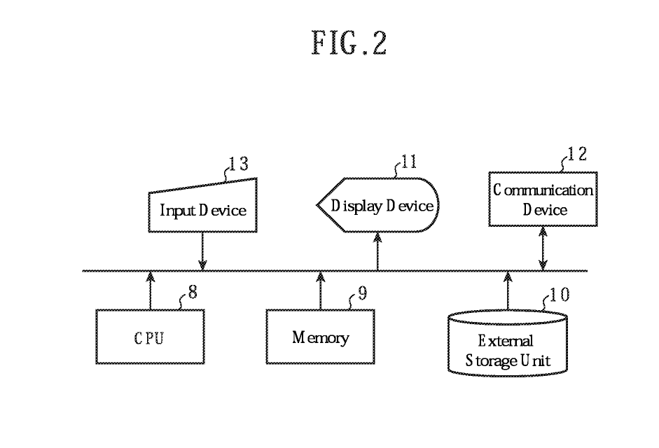

FIG. 2 is a block diagram showing a hardware configuration of an information processing system to which a data access device in accordance with the present invention is applied. As the information processing system, are mentioned mobile information terminals such as a car navigation system, cellular phone and PDA (Personal Digital Assistant). In FIG. 2, the external storage unit 10 stores a data access application program satisfying the purposes of the present invention, application software for implementing processing such as car navigation executed by the information processing system, a software library in which various functional units in the processing are installed, and data used in the processing by the application software (such as map data).

Incidentally, as the external storage unit 10, are mentioned a hard disk drive (HDD), a storage medium such as a CD or DVD and its drive, and a USB (Universal Serial Bus) memory.

The data access application program, application software program and software library are developed from the external storage unit 10 onto the memory 9, and are executed by the CPU 8. The CPU 8 implements, by executing the data access application program, the data definition information input unit 2, data definition information analysis unit 3, data management data generating unit 4, data access program generating unit 5, data management data output unit 6, and data access program output unit 7 shown in FIG. 1 as concrete means incorporating the hardware and software.

A calculation result by the CPU 8 is supplied to the display device 11 via a bus and is displayed on its screen. The display device 11 executes map display and the like in the car navigation, for example. As the display device 11, is mentioned a liquid crystal display or a plasma display.

The communication device 12, a device for carrying out communication with the outside, receives GPS (Global Positioning System) radio waves or FM radio waves.

The input device 13, a device for operation and input from the outside, is implemented by comprising a keyboard, operation switches, a touch panel combined with the display device 11, and the like. In the case of the navigation system, conditions for a route search are input using the input device 13.

Incidentally, although FIG. 2 shows an example in which the external storage unit 10 stores all the data access application program, application software, software library, and the data used in the processing by the application software, a configuration is also possible in which each of them or at least one of them is stored in an individual storage device whose contents are readable by the CPU 8.

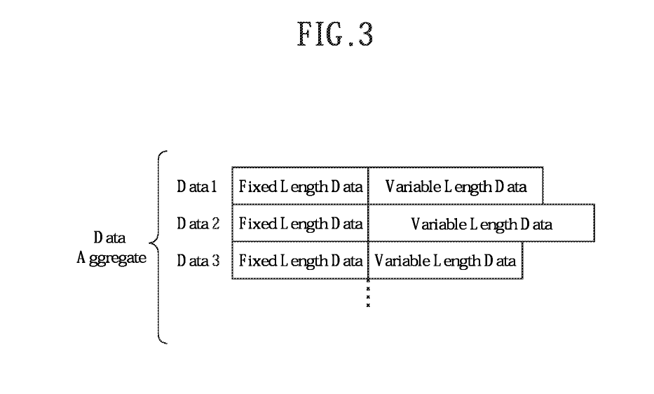

FIG. 3 is a diagram showing an outline of a data aggregate constituting a database or the like, in which the width of a rectangular representing data indicates a data length. As shown in FIG. 3, data 1, 2, 3, . . . , which the present invention deals with consist of two types of data each: fixed length data whose data size is fixed in advance and variable length data whose data size varies in accordance with conditions. In addition, the fixed length data and variable length data each consist of data of individual items of data corresponding to a data format. Such a data aggregate (data group) corresponds to a database or file system to be accessed.

Next, the operation will be described.

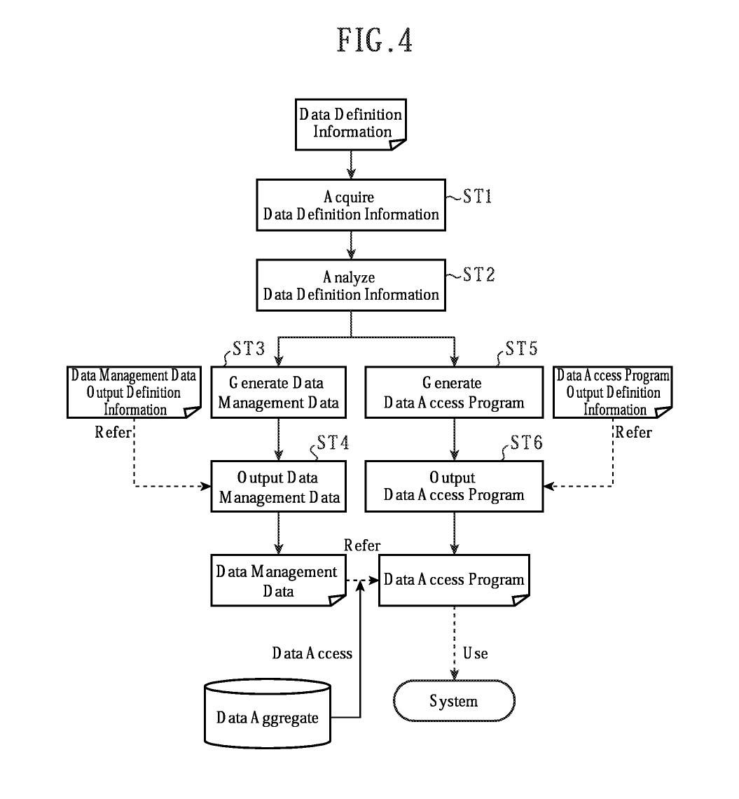

FIG. 4 is a flowchart showing a flow of the operation of the data access device of the embodiment 1. In the following, processing will be described which automatically generates, from the data definition information that defines information indicating storage locations of data in the data aggregate such as a database or file system, the data management data indicating the storage location (offset or address) of each data and the data access program for accessing real data of the data aggregate by referring to the data management data.

First, the data definition information input unit 2 acquires the data definition information by accessing the external storage unit (step ST1). The data definition information acquired by the data definition information input unit 2 is supplied from the data definition information input unit 2 to the data definition information analysis unit 3.

The data definition information analysis unit 3 analyzes the contents of the data definition information received from the data definition information input unit 2 (step ST2).

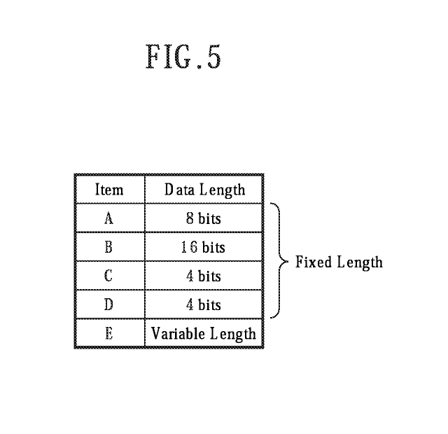

FIG. 5 is a table showing an example of the data definition information. The data definition information, which is set for each data constituting the data aggregate as shown in FIG. 3, has its data and data length defined for each item of the data as shown in FIG. 5. The data specified by the data definition information shown in FIG. 5 includes five items of data A-E, in which items A-D are fixed length data and item E is variable length data.

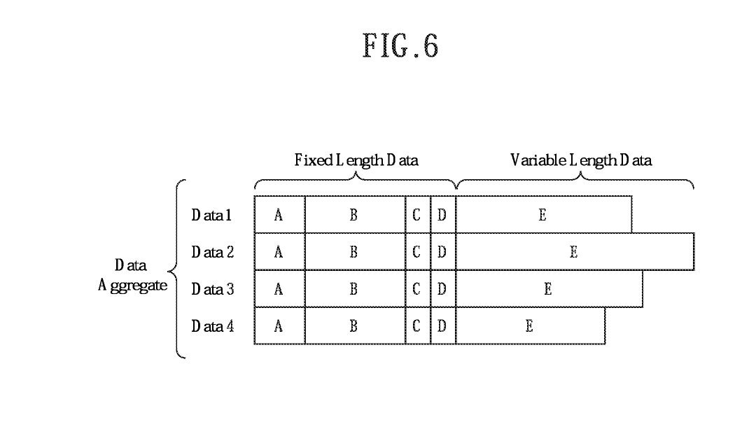

FIG. 6 is a diagram showing an outline of a data aggregate with its individual data structures being specified by the data definition information of FIG. 5, in which the width of a rectangular representing data indicates a data length. As for the data aggregate shown in FIG. 6, data 1, 2, 3, 4, . . . are stored in this order, and the individual data 1, 2, 3, 4, . . . are each provided with the data definition information. The data definition information analysis unit 3 analyzes the contents of the data definition information on the individual data 1, 2, 3, 4, . . . , thereby determining the data of the fixed length items A-D and their data length and the presence or absence of the data of the variable length item E of the individual data 1, 2, 3, 4, . . . as shown in FIG. 6.

At step ST3, the data management data generating unit 4 generates the data management data from the analysis result of the data definition information analysis unit 3. Here, a case will be described in which it determines the real data structure of the data aggregate from the fixed length data items and their data lengths and the presence or absence of the variable length data items of the individual data by analyzing the data definition information, and generates the data management data that defines an offset to the top of the individual data from the real data structure.

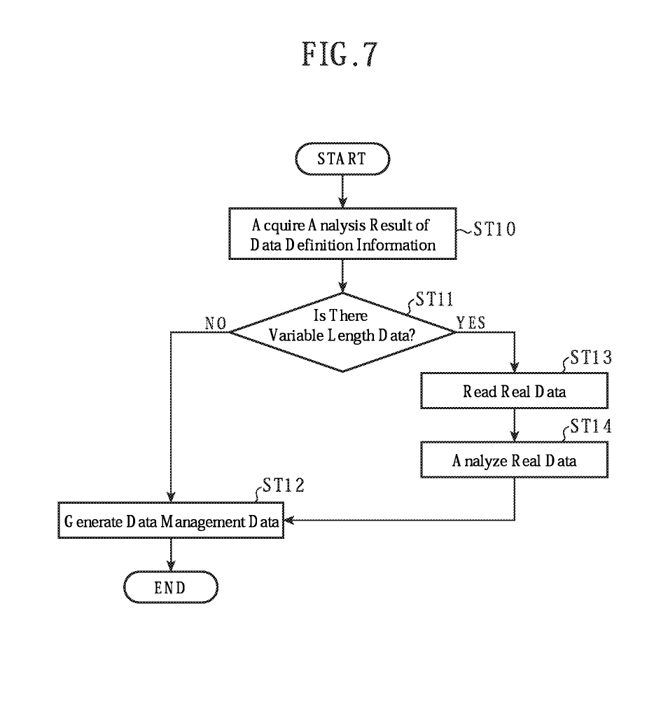

FIG. 7 is a flowchart showing a flow of generating the data management data with the data management data generating unit, which shows details of step ST3 of FIG. 4.

First, the data management data generating unit 4 acquires the analysis result of the data definition information analysis unit 3 (step ST10). Subsequently, the data management data generating unit 4 decides on whether there is variable length data in the data whose structure is defined by the data definition information from the analysis result of the data definition information acquired (step ST11). If no variable length data is present in the data (NO at step ST11), the data management data generating unit 4 determines offsets to individual items from the fixed length data items and their data lengths in the data, and generates the data management data in which the offsets are set (step ST12).

On the other hand, if variable length data is present in the data (YES at step ST11), the data management data generating unit 4 reads the real data of the data from the data aggregate to check the data size of the variable length data section (step ST13), and analyzes the data size of the variable length data section (step ST14). The data management data generating unit 4 specifies the real data structure including the variable length data items and their data lengths in the data obtained by the analysis in addition to the fixed length data items and their data lengths, and generates from the real data structure the data management data in which the offset values to the individual items are set (step ST12).

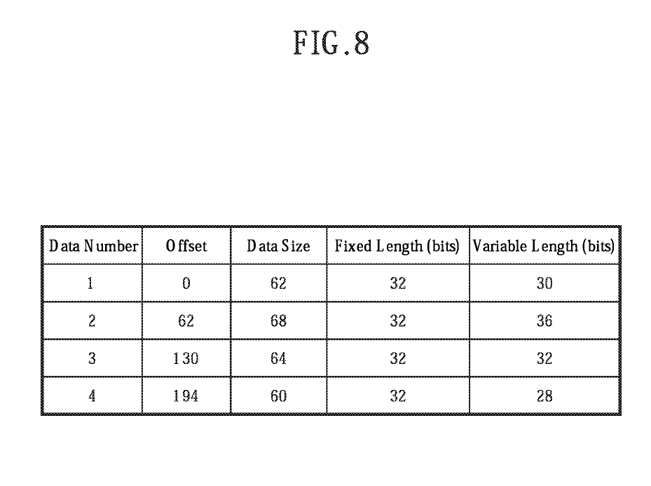

FIG. 8 is a table showing an example of the real data structure of the data aggregate, which shows the real data structure of the data aggregate as shown in FIG. 6 in which the individual data include the variable length data. The data management data generating unit 4 determines the real data structure as shown in FIG. 8 by considering the data size of the variable length data section obtained by analyzing the real data together with the individual items and their data lengths of the fixed length data section.

In the example of FIG. 8, as the real data structure of the data 1, 2, 3, 4 corresponding to the data number 1, 2, 3, 4, are set the offsets for accessing the top of the individual data 1, 2, 3, 4, . . . , the data sizes, fixed lengths (bits) of the fixed length data sections and variable lengths (bits) of the variable length data sections of all the data. Incidentally, as for the offset values shown in FIG. 8, although they are given in terms of the absolute values of data locations from the top, they can also be given in terms of a difference (relative location) from a previous data location.

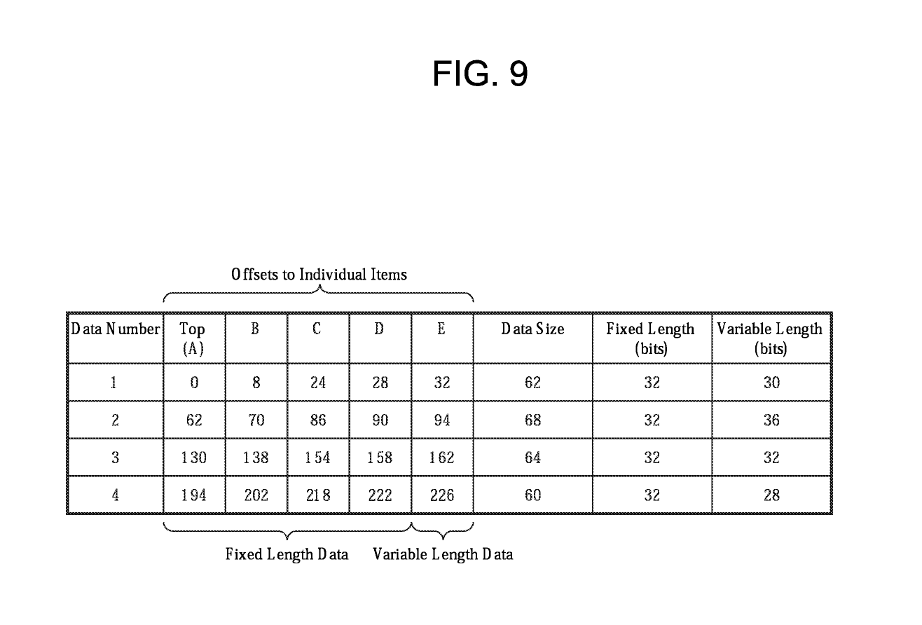

FIG. 9 is a table showing another expression example of the real data structure of the data aggregate, which adds to the real data structure of FIG. 8 the offset values to the individual items. As shown in FIG. 9, as the real data structure of the data 1, 2, 3, 4, the offsets to the individual items A-E are set. Generating the data management data on the basis of the real data structure makes it possible to access the data items of the data 1, 2, 3, 4 efficiently. For example, access to the item C in the data with data number 3 can be designated easily.

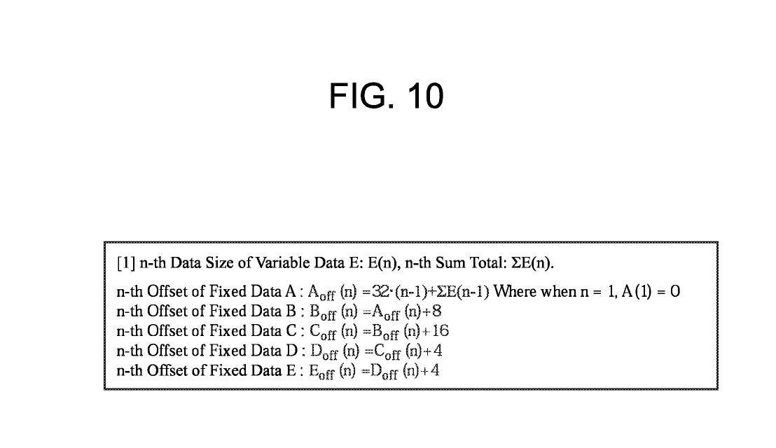

FIG. 10 is a diagram showing another expression example of the real data structure of the data aggregate, which adds to the real data structure of FIG. 9 offsets to the individual items of data, which are given in terms of expressions. The offset to each item can be given in terms of an expression using a data number n as a variable by determining the data size of the fixed length data section from the analysis result of the data definition information and by determining the data size of the variable length data section by the real data analysis.

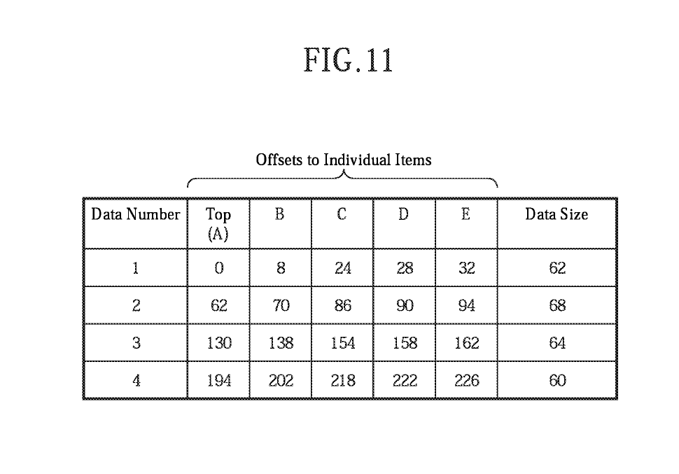

FIG. 11 is a table showing an example of the data management data. As shown in FIG. 11, the data management data is generated for each data of the data aggregate, and the offset values and data sizes to the individual items A-E in the corresponding data are set.

Let us return to the explanation of FIG. 4.

Receiving the data management data the data management data generating unit 4 generates, the data management data output unit 6 refers to the data management data output definition information, and outputs the data management data corresponding to the definition contents of objects to be output (step ST4).

For example, as for a function that requires the data of all the items A-E shown in FIG. 11, it outputs the data management data shown in FIG. 11 by defining the items A-E in the data management data output definition information in advance as items to be output.

In addition, there are some cases where data items used in the processing vary depending on a function.

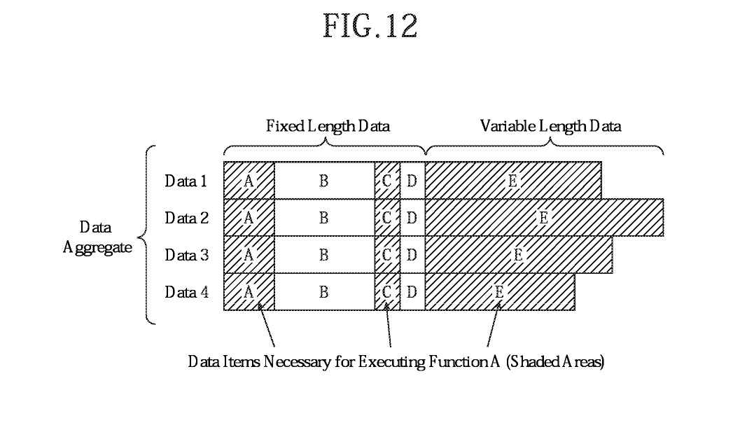

FIG. 12 is a diagram showing data items necessary for executing a function A, which shows that the data items required for executing the function A are the data of the items A, C and E of the individual data 1-4 in the data aggregate shown in

FIG. 6. In this case, among the data management data indicating the data locations of the data aggregate shown in FIG. 6, if the data management data which includes only the data necessary for gaining access to the items A, C and E is output, it will become possible to have efficient access to the data of the items A, C and E. Thus, the present invention defines only the data management data necessary for gaining access to the data of each function by using the data management data output definition information.

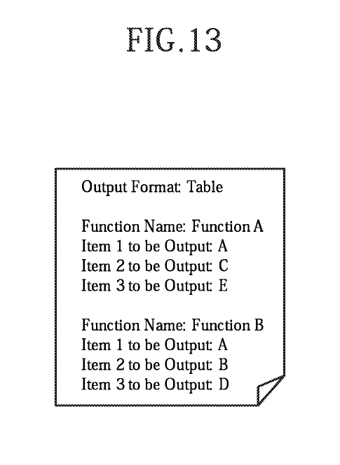

FIG. 13 is a diagram showing an example of the data management data output definition information. The data management data output definition information defines an output format and output items for each function as the information that defines the data management data about items to be output. In the example shown in FIG. 13, as the data necessary for executing the function A, the data of items A, C and E in the data aggregate shown in FIG. 6 is set as items to be output 1, 2 and 3. In addition, as the data necessary for executing the function B, the data of items A, B and D in the data aggregate shown in FIG. 6 is set as items to be output 1, 2 and 3.

The data management data output definition information can be described in terms of an XML (eXtensible Markup Language) format or text format. In addition, the data management data output definition information is stored in advance in a memory whose storage contents are readable by the data management data output unit 6. For example, a memory is used which is included in the computer functioning as the data access device 1. Incidentally, a configuration is also possible which can add or update the data management data output definition information by external operation using the input device 13.

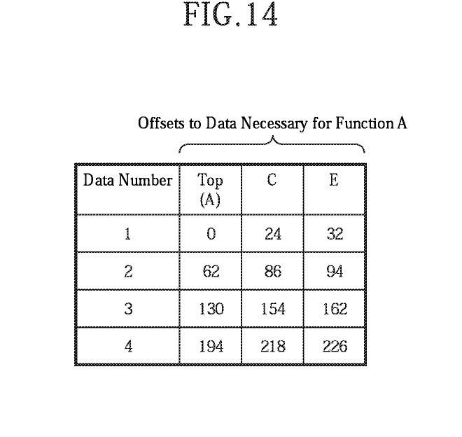

FIG. 14 is a diagram showing an example of the data management data, which shows the data management data that sets the offsets to the data necessary for executing the function A. Referring the data management data output definition information as shown in FIG. 13, the data management data output unit 6 extracts the offsets to the items A, C and E, which are the data items necessary for executing the function A, from the data management data which sets the offsets to the individual items A-E shown in FIG. 11 as the data management data corresponding to the function A, and generates the data management data that sets the data necessary for having access to the items A, C and E as shown in FIG. 14.

In addition, the data management data output unit 6 supplies the data management data to the external storage unit 10 of FIG. 2 to be kept, for example. When using the data management data, the CPU 8 develops it on the memory 9 from the external storage unit 10 and refers to the contents.

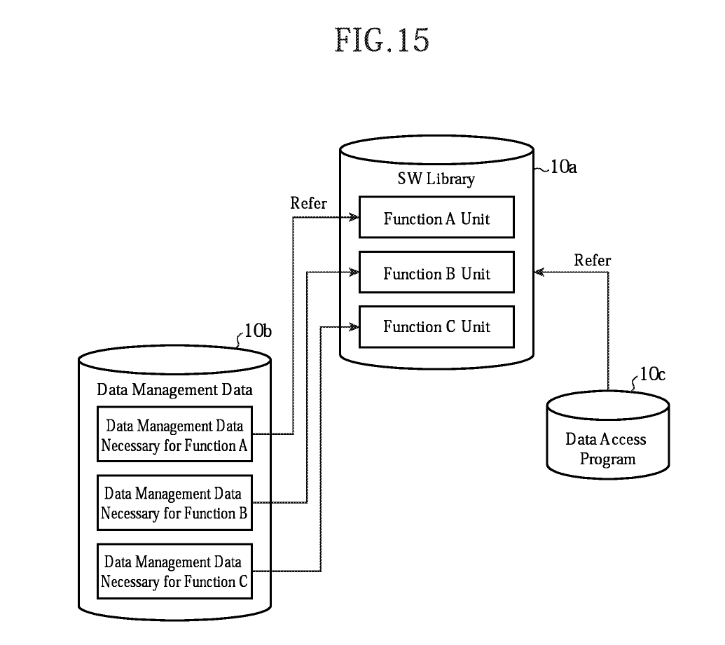

FIG. 15 is a diagram showing an outline of a usage pattern of the data management data generated for each function. A system like a car navigation system (the information processing system shown in FIG. 2) executes various functions using a software library (referred to as an SW library from now on) that stores various program elements for implementing the various functions (such as a route search and map display).

As shown in FIG. 15, an example will be described in which program elements of the function A, function B and function C are installed in the SW library 10a of the system. In this case, the data management data (the data management data necessary for the function A, the data management data necessary for the function B and the data management data necessary for the function C) 10b are generated for the individual functions, and are installed in the system together with the data access program 10c. Incidentally, a term “program element” refers to functions and their attributes used by the program, and a class, package and method for classifying them.

When the CPU 8 (see FIG. 2) of the system executes an application relating to the function A, for example, the program element of the function A in the SW library 10a is executed and operates as a function A unit. In this case, the function A unit executes the data access program 10c and determines the storage locations by referring to the data management data necessary for the function A, thereby acquiring the data necessary for executing the function A from the data aggregate. By thus doing, efficient access to desired data is carried out.

Let us return to the description of FIG. 4.

The data access program generating unit 5 receives the analysis result of the data definition information from the data definition information analysis unit 3, and generates a data access program from the analysis result (step ST5). Here, the data access program for having data access to the data aggregate is generated by using the data aggregate to be accessed and information indicating its data structure, which are acquired from the analysis result of the data definition information.

Subsequently, receiving the data access program the data access program generating unit 5 generates, the data access program output unit 7 outputs the data access program corresponding to the definition contents of objects to be output by referring to the data access program output definition information (step ST6).

In addition, the data access program output unit 7 supplies the data access program to the external storage unit 10 of FIG. 2 to be kept, for example. When executing the data access program, the CPU 8 develops it on the memory 9 from the external storage unit 10 and executes it.

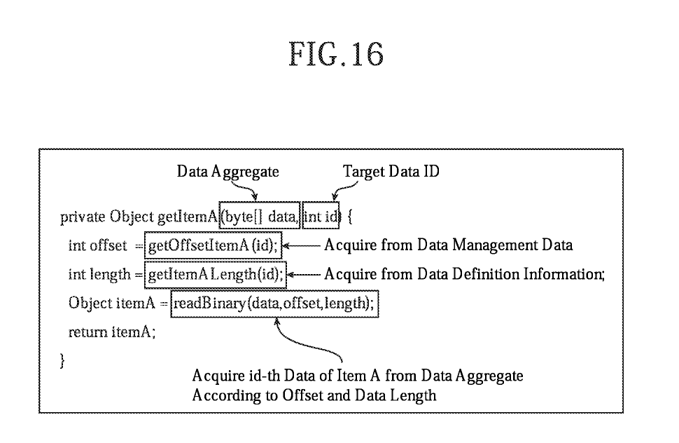

FIG. 16 is a diagram showing an example of the data access program, which shows the data access program for acquiring the data of item A from the data aggregate. In the example shown in FIG. 16, the first line sets the data aggregate to be accessed and its target data ID (data number id), the second line sets the offset to the item A of the id-th data, and the third line sets the data length of the item A. Besides, the fourth line describes that the data of item A in the id-th data is to be acquired.

The data access program generating unit 5 generates, from the data aggregate to be accessed and its data structure obtained as the analysis result of the data definition information, the data access program for acquiring individual data (data items) in the data aggregate to be accessed as shown in FIG. 16. For example, as for the target data ID (data number id), fixed length data item and its data length, values acquired from the analysis result of the data definition information are set. On the other hand, as for the data length and offset of a variable length data item, they are set by referring to the data management data when executing the data access program.

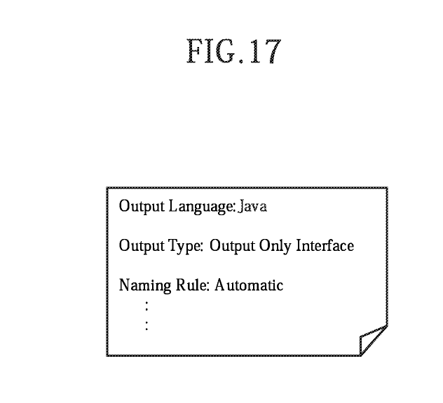

FIG. 17 is a diagram showing an example of the data access program output definition information. As shown in FIG. 17, the data access program output definition information defines the output language, output type, naming rule and the like. For example, if the output language is “Java” (a registered trademark, also in FIG. 17), the program described in Java becomes an object to be output, and if the output type is set at “interface-only output”, an empty implementation program is output. In addition, if the naming rule is set at “automatic”, the class or functions of the data access program are automatically named. These items are variable in accordance with a specification. Incidentally, the information can be described in terms of an XML format or text format.

In addition, the data access program output definition information is stored in advance in a memory whose storage contents are readable by the data access program output unit 7. For example, a memory is used which is included in the computer functioning as the data access device 1. Incidentally, a configuration is also possible which can add or update the data access program output definition information by external operation using the input device 13.

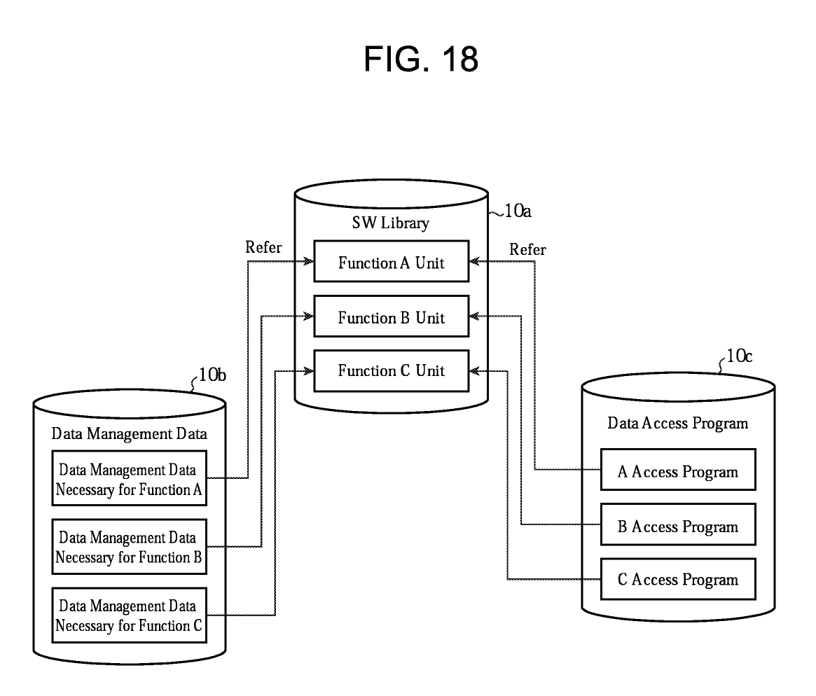

FIG. 18 is a diagram showing an outline of a usage pattern of the data management data and data access program generated for each function. As shown in FIG. 18, an example will be described in which the program elements of the function A, function B and function C are installed in the SW library 10a and the data management data for individual functions (the data management data necessary for the function A, the data management data necessary for the function B and the data management data necessary for the function C) 10b are installed in the system.

In this case, referring to the data access program output definition information, the data access program output unit 7 generates data access programs for individual functions (A access program, B access program and C access program) 10c from the data access program generated by the data access program generating unit 5, and installs into the system.

When the CPU 8 (see FIG. 2) of the system executes an application relating to the function A, for example, the program element of the function A in the SW library 10a is executed and operates as the function A unit. In this case, if the function A unit executes the A access program corresponding to the function A, it can acquire the necessary data from the data aggregate by determining the storage location by referring to the data management data necessary for the function A. In this way, using different data management data and data access programs for different functions enables efficient and quick access to desired data.

As described above, according to the present embodiment 1, the information processing system like a navigation system comprises the data management data that defines the storage locations of the real data in the data group on the basis of the data definition information indicating the data structure of the data group (data aggregate), and the data access program that describes the access function to the real data in which the data structure is specified on the basis of the data definition information; determines the storage locations of the real data by referring to the data management data; and accesses the real data in the data group by executing the data access program. Doing in this way enables efficient and quick access to the desired data.

In addition, according to the present embodiment 1, it comprises the data definition information input unit 2 for acquiring the data definition information indicating the data structure of the data group retaining the real data; the data definition information analysis unit 3 for analyzing the contents of the data definition information acquired by the data definition information input unit 2; the data management data generating unit 4 for generating the data management data that defines the storage location of the real data in the data group from the data structure of the data group obtained by analyzing the data definition information by the data definition information analysis unit 3; the data access program generating unit 5 for generating the data access program that describes the access function to the real data whose data structure in the data group is specified by analyzing the data definition information by the data definition information analysis unit 3; the data management data output unit 6 for producing the data management data that satisfies the contents to be output from the data management data generated by the data management data generating unit 4 by referring to the data management data output definition information that defines the contents to be output of the data management data; and the data access program output unit 7 for producing the data access program that satisfies the contents to be output from the data access program generated by the data access program generating unit 5 by referring to the data access program output definition information that defines the contents to be output of the data access program. With such an arrangement, it can automatically generate the data management data and data access program, which are used for having access to the desired data efficiently and quickly.

### Embodiment 2

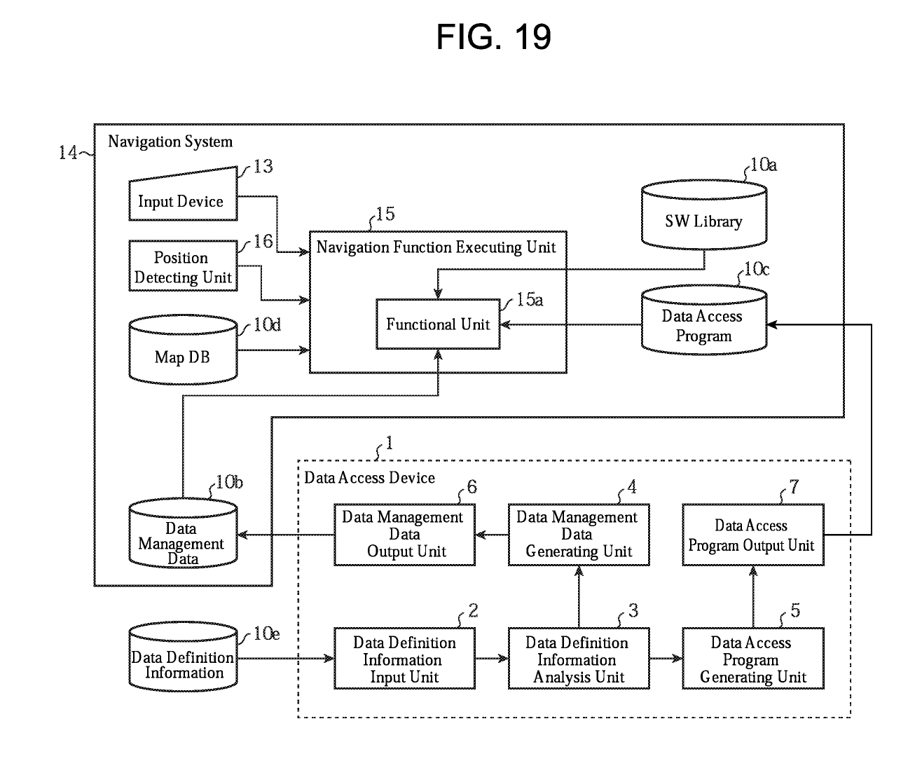

FIG. 19 is a block diagram showing a configuration of a navigation system of an embodiment 2 in accordance with the present invention. In FIG. 19, the same components as those of FIG. 1 and FIG. 2 are designated by the same reference numerals and their description will be omitted. The navigation system 14 of the embodiment 2 is a navigation system to which the data access device 1 of the embodiment 1 is applied, and into which the data management data 10b and data access program 10c generated by the data access device 1 are installed.

The SW library 10a has program elements installed for achieving various functions of the navigation system 14. For example, an object relating to a route search has a hierarchical structure consisting of program elements for implementing the various functions in the route search.

A map database (map DB) 10d is a data aggregate comprising map data. In addition, the navigation system 14 is implemented by the hardware configuration as shown in FIG. 2. Here, the SW library 10a, data management data 10b, data access program 10c and map DB 10d are stored in the external storage unit 10.

The navigation function executing unit 15, which is a component for executing various functions relating to the navigation, is implemented by the CPU 8 that executes applications concerning the navigation. In this case, the CPU 8 executes the program element of a particular function of the SW library 10a, thereby operating as a functional unit 15a that executes the function. Referring to the data management data 10b, the functional unit 15a executes the data access program 10c, thereby acquiring the necessary data from the map DB 10d.

A position detecting unit 16 is a component for detecting the position of a vehicle that is equipped with the navigation system 14, and obtains the current position of the vehicle using GPS signals or map matching with measured values of a sensor group such as a vehicle speed sensor and gyro-sensor.

The data definition information 10e, which defines the map data structure of the map DB 10d, is stored in the storage apparatus whose storage contents are readable by the data definition information input unit 2.

Next, the operation will be described.

Here, an example of generating the data management data for the map graphic data of the map DB 10d will be described.

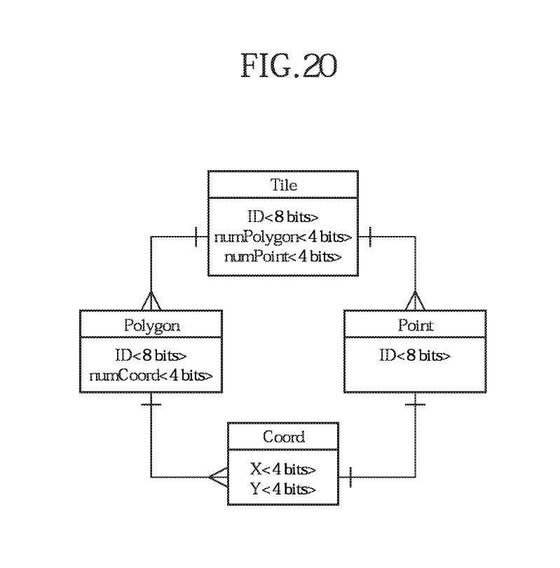

FIG. 20 is an ER (Entity Relationship) diagram that defines the data structure of a polygon and a point in the map DB of FIG. 19, which defines the data structure of a polygon and a point as map graphics. As shown in FIG. 20, polygons and points belong to a tile, and their coordinates on a display screen are set. In addition, as for the data on the polygons and points, since the number of data varies depending on the values set to parameters numPolygon, numPoint and numCoord, the data are variable length data.

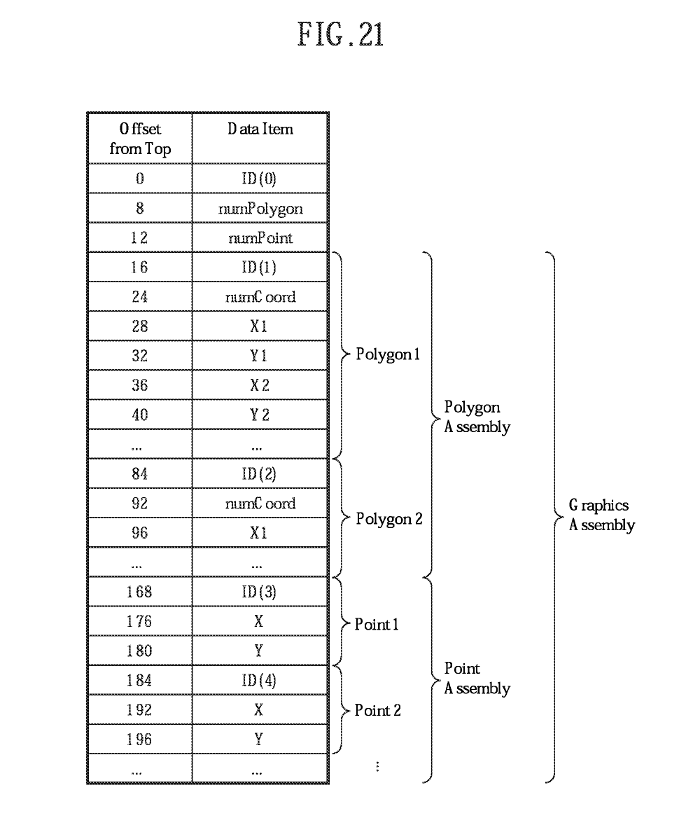

FIG. 21 is a diagram showing map graphic data constructed in accordance with the definition of FIG. 20, which shows data aggregates of map graphics in the map DB 10d. Incidentally, the data structure of FIG. 21 corresponds to one of the data 1-4 in the data aggregate shown in FIG. 6, for example.

The data management data generating unit 4 decides on whether the map graphic data defined by the data definition information contains variable length data or not from the analysis result of the data definition information received from the data definition information analysis unit 3. As described above, since the data on the polygons and points are variable length data, the data management data generating unit 4 reads the real data on the polygons and points from the map DB 10d and analyzes the data sizes of the variable length data.

According to the analysis, the data management data generating unit 4 obtains the variable length data items (values of the parameters numPolygon and numPoint of FIG. 21, and the coordinate data on polygons 1 and 2 and points 1 and 2 set in the parameter numCoord) of the data and their data lengths, specifies the real data structure with the fixed length data items (Ids of the tile, polygons 1 and 2, and points 1 and 2 of FIG. 21) together with their data lengths, and generates the data management data that sets offset values to the individual items from the real data structure.

Receiving the data management data the data management data generating unit 4 generates, the data management data output unit 6 outputs the data management data defined by the data management data output definition information, and incorporates into the navigation system 14.

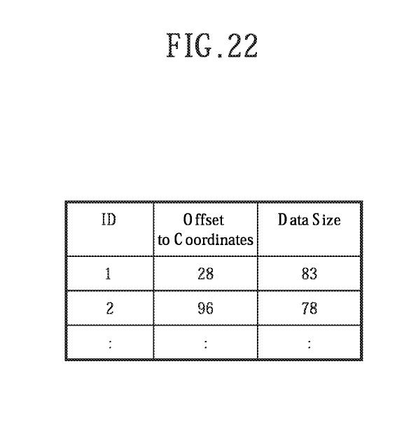

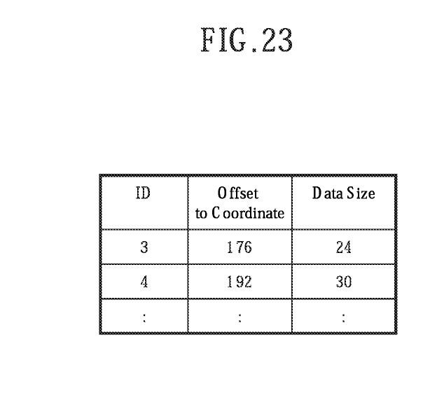

FIG. 22 is a table showing the data management data for polygon graphics and FIG. 23 is a table showing the data management data for point graphics.

For example, the data management data output unit 6 extracts the coordinates of the polygons from the data management data the data management data generating unit 4 generates and generates the data management data shown in FIG. 22 by defining as the data management data output definition information the coordinates (Coord) of the polygons in the data necessary for executing map drawing.

Likewise, the data management data output unit 6 extracts the coordinates of the points from the data management data the data management data generating unit 4 generates and generates the data management data shown in FIG. 23 by defining as the data management data output definition information the coordinates (Coord) of the points.

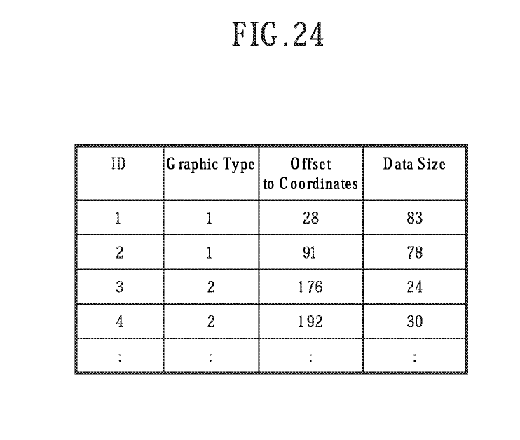

FIG. 24 is a table showing the data management data for managing both the polygon graphics and point graphics. When the data management data output definition information defines the coordinates of the polygons and points as the data necessary for executing map drawing, for example, the data management data output unit 6 generates the data management data for managing the coordinate data of the polygons and points on a single table as shown in FIG. 24. In this case, it is also possible to provide the data management data including a graphic type column, and to set identification information for identifying polygons and points. In the example of FIG. 24, a graphic type “1” represents a polygon graphic and a graphic type “2” represents a point graphic.

The data management data 10b and data access program 10c generated as described above are incorporated into the navigation system 14.

To execute a function such as a route search or map display, the functional unit 15a executes the data access program 10c, thereby acquiring necessary map graphic data from the map DB 10d by referring to the offset values of the data management data 10b. Doing in this way enables efficient and quick access to the desired map data.

In addition, it is also possible to generate the data management data 10b for each navigation function such as a route search or map display by designating the contents of the data management data output definition information in the same manner as the foregoing embodiment 1. In this case, for each navigation function, the addresses or offsets of the data necessary for executing the navigation function are assigned to the data management data 10b.

Thus classifying and managing the data for each function can facilitate the maintenance of the data.

Furthermore, together with the generation of the data management data 10b for each navigation function, it is also possible to generate the data access program 10c for each navigation function such as a route search or map display by designating the contents of the data access program output definition information in the same manner as the foregoing embodiment 1.

In this case, the functional unit 15a of the navigation function executing unit 15 gains access to the map DB 10d by referring to the data management data 10b of the corresponding navigation function by executing the data access program 10c, thereby acquiring the data necessary for the navigation function.

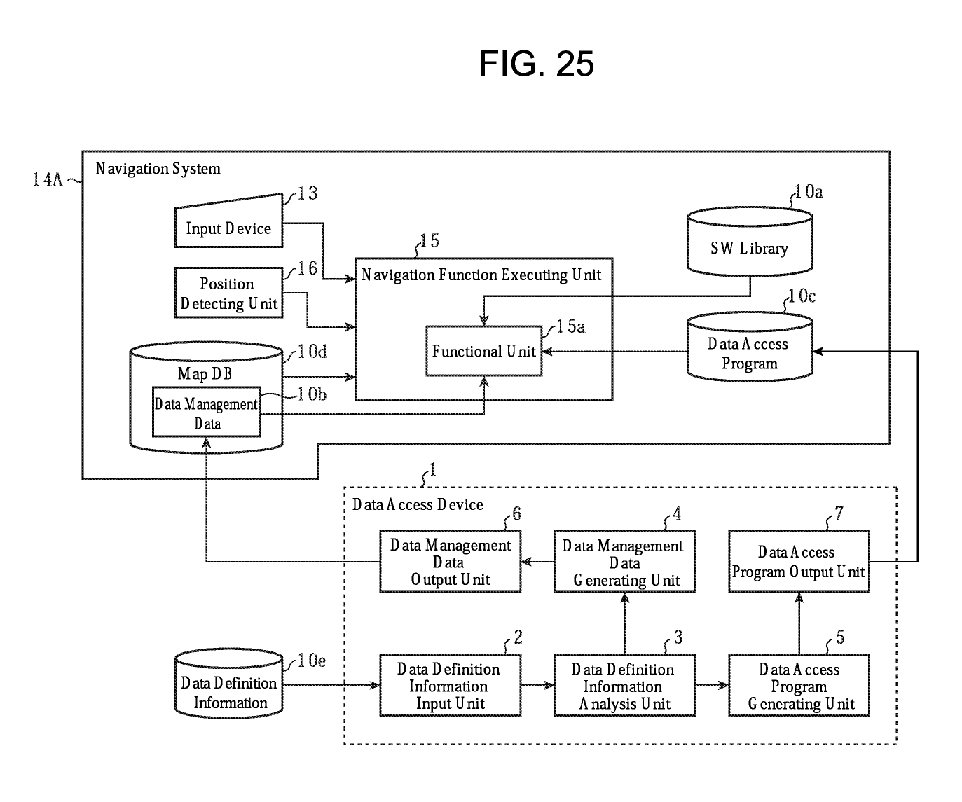

FIG. 25 is a block diagram showing another configuration of the navigation system of the embodiment 2. The description so far shows an example that sets the data management data 10b and map DB 10d separately. However, the navigation system 14A shown in FIG. 25 has the data management data 10b and map DB 10d as integrated data.

This enables more efficient and quick access to desired map data as compared with the case of setting them as separate data, by providing the data management data for each mesh of the map data and by locating in the map DB the storage location of the data necessary for processing each mesh by referring to the data management data corresponding to the mesh, for example.

As described above, according to the present embodiment 2, it comprises the data management data 10b which defines the storage locations of the real data in the map DB 10d in accordance with the data definition information 10e indicating the data structure of the map DB 10d that stores the real data of the map data; the data access program 10c that describes the access function to the real data whose data structure in the map DB 10d is specified by the data definition information 10e; and the functional unit 15a for determining the storage locations of the real data by referring to the data management data 10b and for gaining access to the real data of the map DB 10d by executing the data access program 10c. Accordingly, it can access the desired map data efficiently and quickly.

In addition, according to the present embodiment 2, since the data management data is the data that defines the storage locations of the real data used for the individual functions of the navigation, it can gain access to the map data used for the individual functions of the navigation efficiently and quickly. Furthermore, since the map data is classified in accordance with the individual functions, it can facilitate maintenance of the map data.

In addition, according to the present embodiment 2, since the data access program is a program that describes the access functions to the real data used for the individual functions of the navigation, it can access the map data corresponding to the individual functions efficiently and quickly.

Furthermore, according to the present embodiment 2, since the data management data is made an integral part of the map DB 10d as shown in FIG. 25, it can gain access to the desired map data more efficiently and quickly as compared with the case where it is made separate data.

### Embodiment 3

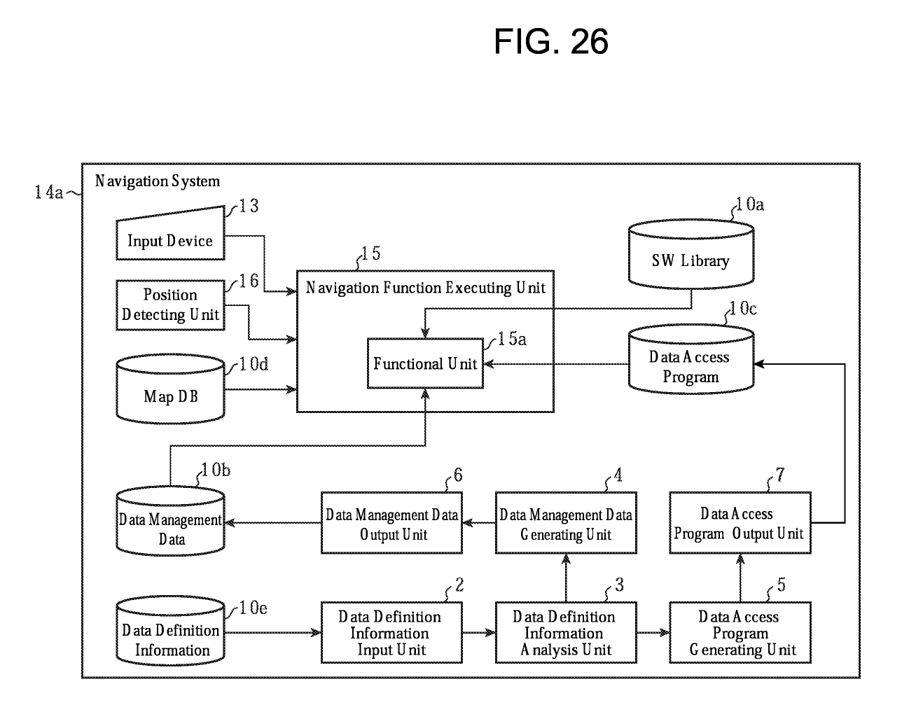

FIG. 26 is a block diagram showing a configuration of a navigation system of an embodiment 3 in accordance with the present invention. In FIG. 26, the same components as those of FIG. 1, FIG. 2 and FIG. 19 are designated by the same reference numerals and their description will be omitted. The navigation system 14a of the embodiment 3 comprises in addition to the configuration of the navigation system 14 of the foregoing embodiment 2 the data definition information input unit 2, data definition information analysis unit 3, data management data generating unit 4, data access program generating unit 5, data management data output unit 6 and data access program output unit 7, which are components of the foregoing data access device 1 of the embodiment 1.

The data management data output from the data management data output unit 6 is stored in the external storage unit 10 or the like as shown in FIG. 2 as the data management data 10b. Likewise, the data access program output from the data access program output unit 7 is stored in the external storage unit 10 or the like as the data access program 10c.

The navigation function executing unit 15 (functional unit 15a) determines the storage locations of the real data by referring to the data management data 10b, and accesses the map DB 10d by executing the data access program 10c, thereby acquiring the real data used for the processing concerning the navigation.

As described above, according to the embodiment 3, since the navigation system 14a includes the configuration of the data access device 1, the navigation system 14a itself can generate the data management data 10b and data access program 10c automatically without waiting for the data access device 1 to incorporate the data management data 10b and data access program 10c as in the foregoing embodiment 2.

### Embodiment 4

The present embodiment 4 shows a usage mode as a navigation system as in the foregoing embodiments 2 and 3. In the navigation system, if terrestrial facilities such as roads and buildings constituting a map change, it becomes necessary to update a map database in accordance with the changes. In addition, there are some cases that involve alteration of the data structure (data format) such as adding attributes of the map data in the update of the map database. Thus, when the update of the map database is necessary, the navigation system of the embodiment 4 updates the data definition information in such a manner as to show the data structure of the map database to be updated, which includes data about the terrestrial facilities to be updated, thereby enabling efficient and quick data access even if the map data is updated.

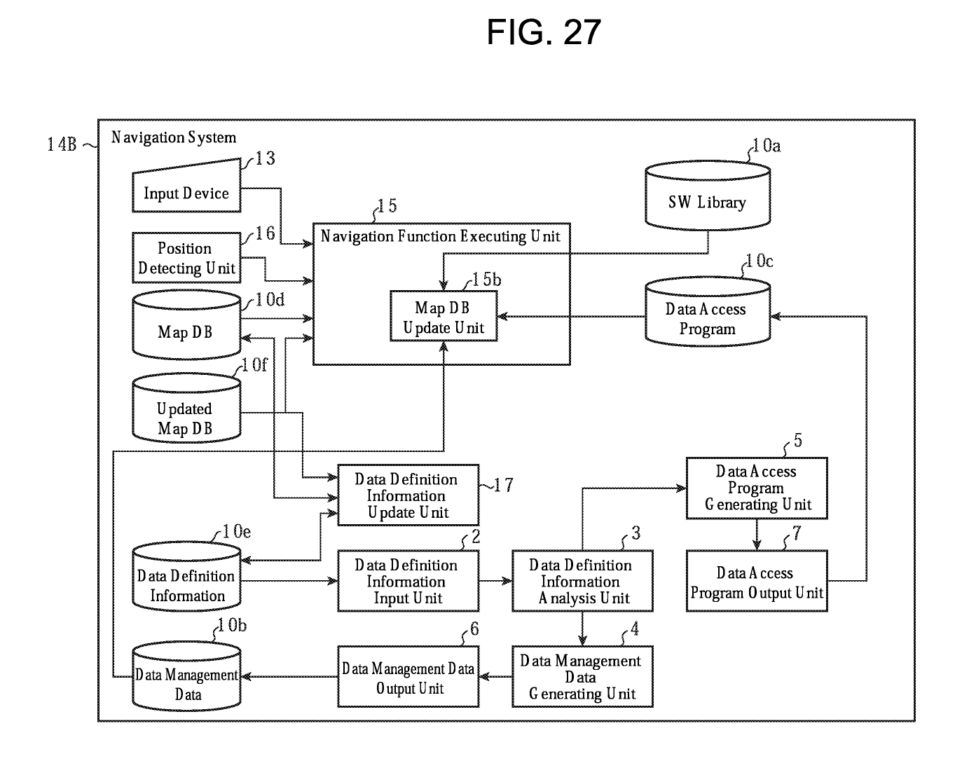

FIG. 27 is a block diagram showing a configuration of the navigation system of the embodiment 4 in accordance with the present invention. In FIG. 27, the same components as those of FIG. 1, FIG. 2 and FIG. 19 are designated by the same reference numerals and their description will be omitted. The navigation system 14B of the embodiment 4 comprises in addition to the configuration of the navigation system 14a of the foregoing embodiment 3 an update map database (DB) 10f, a map DB update unit 15b and a data definition information update unit 17. Incidentally, the navigation system 14B is implemented with the hardware configuration as shown in FIG. 2.

The updated map DB 10f is a map database including the map data of terrestrial facilities changed. The SW library 10a, data management data 10b, data access program 10c, map DB 10d, data definition information 10e and updated map DB 10f are stored in the external storage unit 10 shown in FIG. 2.

In addition, causing the CPU 8 to execute a program element of the map DB update function in the SW library 10a enables the CPU 8 to operate as the map DB update unit 15b that executes the function.

The map DB update unit 15b is a component that executes the data access program 10c generated using the data definition information after the update, and acquires the map data from the map DB 10d and updated map DB 10f by referring to the data management data generated using the data definition information after the update, thereby reflecting the map data contents after the update in the navigation processing.

The data definition information update unit 17 is a component for updating the existing data definition information (data definition information of the map DB 10d) by using difference data about a portion to be changed (terrestrial facilities to be updated) between the existing map DB 10d and the updated map DB 10f.

Next, the operation will be described.

### (1) Update of Data Definition Information.

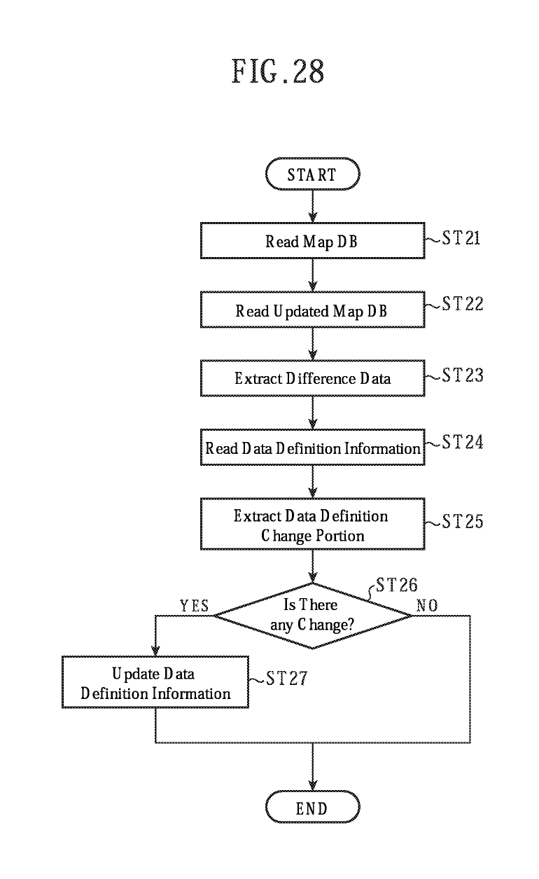

FIG. 28 is a flowchart showing a flow of the update processing of the data definition information by the navigation system of the embodiment 4.

First, the data definition information update unit 17 reads the map data of the existing map DB 10d (step ST21), and then reads the map data of the updated map DB 10f (step ST22). For example, it reads the map data contained in tiles at corresponding locations in the map DB 10d and updated map DB 10f on a tile by tile basis.

Next, the data definition information update unit 17 compares the map data it successively reads from the map DB 10d and updated map DB 10f, and extracts the difference data corresponding to the a portion to be changed (terrestrial facilities to be updated) (step ST23). For example, in a case where the data size of the data item A in the map DB 10d is 2 bits, but the data size of the data item A of the updated map DB 10f becomes 4 bits, it specifies the changes in the data size between the corresponding data as the difference data. Incidentally, even if there is no change, it extracts the difference data with a data size change=0.

Extracting the difference data between the map data of the map DB 10d and the map data of the updated map DB 10f, the data definition information update unit 17 reads the data definition information corresponding to the map data (step ST24), compares the difference data with the data definition information, and extracts a portion to be changed in the data definition information (step ST25).

Here, the data definition information update unit 17 decides on whether the data definition information has a substantial change or not (step ST26). If the data definition information does not have any change because of the difference data with the data size change=0 (NO at step ST26), the data definition information update unit 17 terminates the update processing of the data definition information corresponding to the map data.

On the other hand, if the data definition information has a change (YES at step ST26), the data definition information update unit 17 updates the data definition information in such a manner as to reflect the difference data (step ST27). For example, if the data size of the data item A of the updated map DB 10f becomes 4 bits as mentioned above, it revises the data item A of the data definition information to the data item A of the updated map DB 10f with the data size of 4 bits.

### (2) Update of Data Management Data.

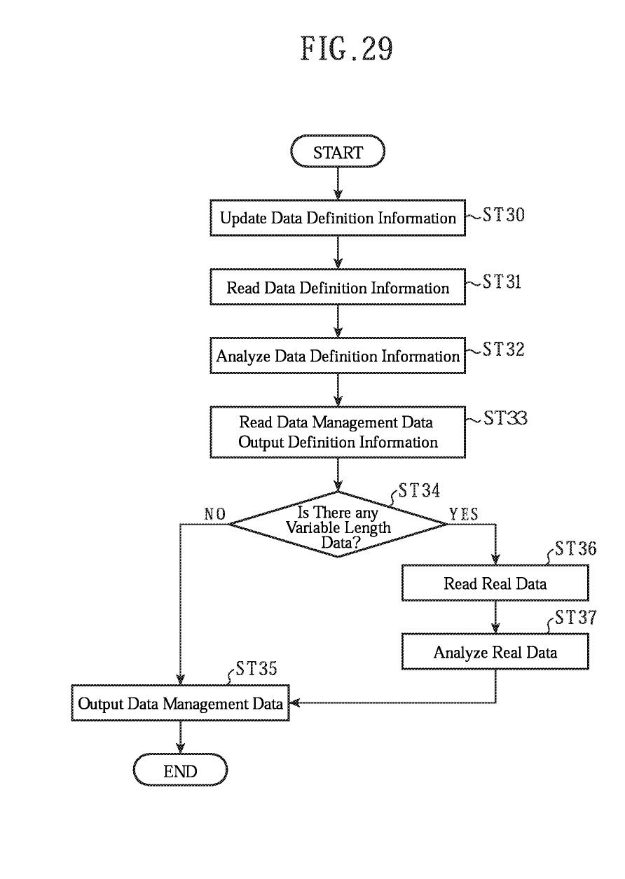

FIG. 29 is a flowchart showing a flow of the update processing of the data management data by the navigation system of the embodiment 4.

The data definition information update unit 17 updates the data definition information (step ST30). The processing corresponds to the processing of FIG. 28 described above. Subsequently, the data definition information input unit 2 acquires the updated data definition information (step ST31). The data definition information acquired by the data definition information input unit 2 is supplied from the data definition information input unit 2 to the data definition information analysis unit 3.

The data definition information analysis unit 3 analyzes the contents of the data definition information supplied from the data definition information input unit 2 (step ST32). After that, the data management data output unit 6 reads the data management data output definition information (step ST33).

Next, the data management data generating unit 4 decides on whether the map data whose structure is defined by the data definition information includes variable length data or not from the analysis result of the data definition information fed from the data definition information analysis unit 3 (step ST34). Unless the map data includes the variable length data (NO at step ST34), the data management data generating unit 4 determines offsets to individual items from fixed length data items and their data lengths in the map data, and generates the data management data in which the offsets are set. After that, the processing proceeds to step ST35.

On the other hand, if the data includes variable length data (YES at step ST34), the data management data generating unit 4 reads the real data of the map data from the updated map DB 10f to check the data size of the variable length data section (step ST36), and analyzes the data size of the variable length data section (step ST37). According to the analysis, the data management data generating unit 4 obtains the variable length data items and their data lengths in the map data, specifies the real data structure considering together with them the fixed length data items and their data lengths, and generates the data management data that sets the offset values to the individual items on the basis of the real data structure. After that, the processing proceeds to step ST35.

At step ST35, the data management data output unit 6 acquires the data management data the data management data generating unit 4 generates (the data management data corresponding to the updated map DB 10f), outputs the data management data corresponding to the definition contents of objects to be output by referring to the data management data output definition information and stores in the storage apparatus (external storage unit 10 or the like of FIG. 2).

### (3) Generation of Data Access Program.

When the map data in the updated map DB 10f includes a new data item, a data access program for acquiring the data of the new item becomes necessary.

In this case also, in the same manner as the foregoing embodiment 1, the data access program generating unit 5 generates the data access program for acquiring the map data (data items) in the updated map DB 10f from the data structure of the updated map DB 10f obtained as the analysis result of the data definition information after the update.

After that, the data access program output unit 7 acquires the data access program generated in the data access program generating unit 5, outputs the data access program corresponding to the definition contents of objects to be output by referring to the data access program output definition information, and stores it in the storage apparatus (external storage unit 10 or the like of FIG. 2).

(4) Reflection of Updated Map.

When executing a function such as a route search or map display, the map DB update unit 15b of the navigation function executing unit 15 executes the data access program 10c generated in accordance with the data definition information after the update, thereby acquiring necessary map graphic data from the updated map DB 10f by referring to the offset values to the data management data 10b generated in accordance with the data definition information after the update.

As described above, according to the present embodiment 4, it comprises the data definition information update unit 17 for updating, when the map DB 10d is updated as the updated map DB 10f, the data definition information 10e in such a manner that the updated data structure is reflected. With this configuration, it can automatically generate the data definition information 10e corresponding to the updated map DB 10f.

In addition, according to the present embodiment 4, the data definition information update unit 17 extracts a portion to be changed from the map DB 10d by comparing the real data in the existing map DB 10d with the real data in the updated map DB 10f, and updates the data definition information 10e in such a manner as to reflect the data structure in the portion to be changed. By thus doing, it can automatically generate the data definition information 10e corresponding to the updated map DB 10f.

Furthermore, according to the present embodiment 4, the data definition information analysis unit 3 analyzes, when the data definition information update unit 17 updates the data definition information, the contents of the data definition information after the update; the data management data generating unit 4 generates the data management data 10b that defines the storage locations of the real data in the updated map DB 10f from the data structure of the updated map DB 10f obtained by analyzing the data definition information after the update by the data definition information analysis unit 3; and the data access program generating unit 5 generates the data access program 10c that describes the access function to the real data whose data structure in the updated map DB 10f is specified by analyzing the data definition information after the update by the data definition information analysis unit 3. In this way, when the data definition information is updated to the data definition information 10e corresponding to the updated map DB 10f, the data management data 10b and data access program 10c are automatically updated accordingly. As a result, it can access the map data efficiently and quickly even if the map DB is updated dynamically.

### Embodiment 5

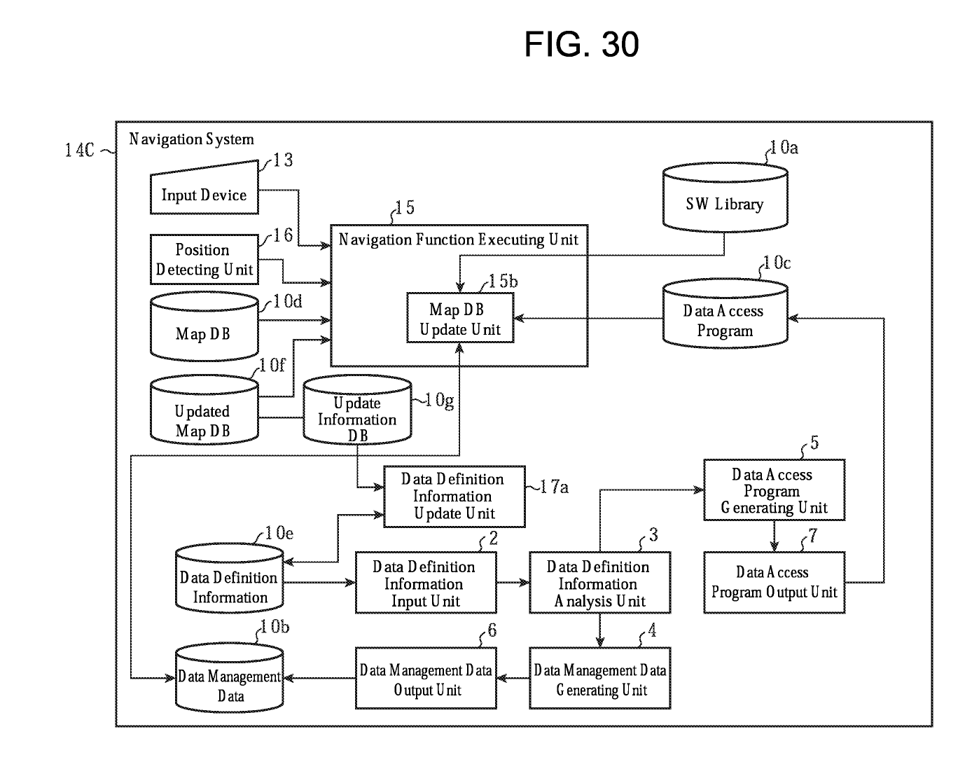

FIG. 30 is a block diagram showing a configuration of a navigation system of an embodiment 5 in accordance with the present invention. In FIG. 30, the same components as those of FIG. 1, FIG. 2, FIG. 19 and FIG. 27 are designated by the same reference numerals and their description will be omitted. the navigation system 14C of the embodiment 5 comprises an update information database (DB) 10g in addition to the configuration of the navigation system 14B of the foregoing embodiment 4, and a data definition information update unit 17a instead of the data definition information update unit 17. Incidentally, the navigation system 14C is implemented by the hardware configuration shown in FIG. 2.

The update information DB 10g is a database for storing the update definition information that defines the update contents in the map data of the updated map DB 10f. The SW library 10a, data management data 10b, data access program 10c, map DB 10d, data definition information 10e, updated map DB 10f and update information DB 10g are stored in the external storage unit 10 of FIG. 2.

In addition, the data definition information update unit 17a is a component for updating the existing data definition information (data definition information of the map DB 10d) using the update definition information read from the update information DB 10g.

Next, the operation will be described.

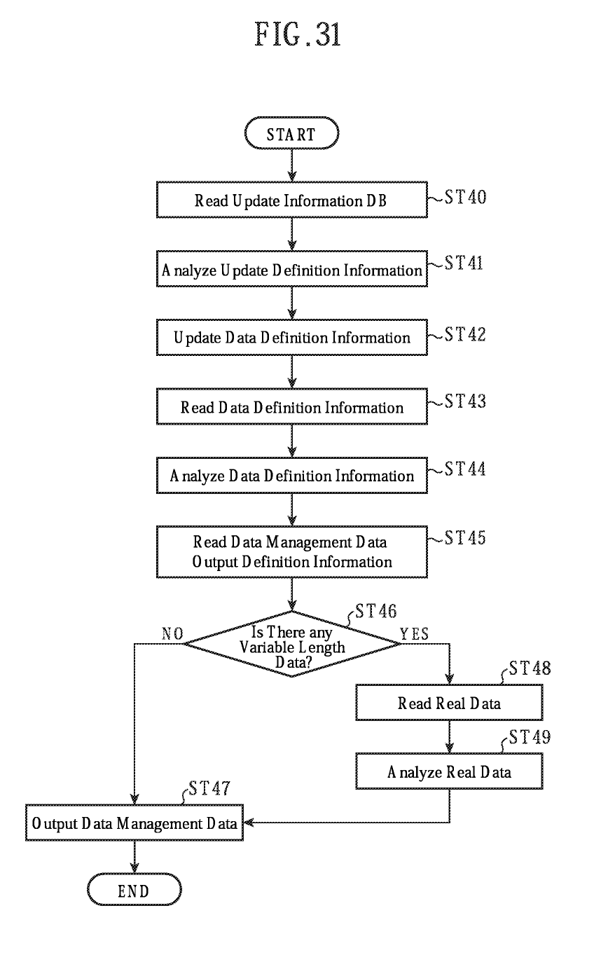

FIG. 31 is a flowchart showing a flow of the update processing of the data definition information and data management data by the navigation system of the embodiment 5.

First, the data definition information update unit 17a reads the update definition information from the update information DB 10g (step ST40), and analyzes the update definition information (step ST41).

Next, the data definition information update unit 17a reads the data definition information corresponding to the map data whose update contents are defined by the update definition information, and updates the data definition information in such a manner as to reflect the analysis result of the update definition information (step ST42).

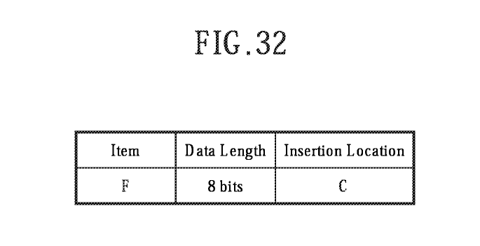

FIG. 32 is a table showing an example of the update definition information. The update definition information shown in FIG. 32 defines an update content that inserts, following an item C in the corresponding map data, the data of an item F with a data length of 8 bits. In such a manner, the update definition information defines, as the update content, a data item to be updated, its data length and an insertion location of the data item in the map data (map data in the existing map DB 10d), for example.

When deleting data by update, set an item to be deleted as a data item to be updated, and assign 0 bit as its data length. Furthermore, when inserting data into the top location of the map data, set “0” to the insertion position.

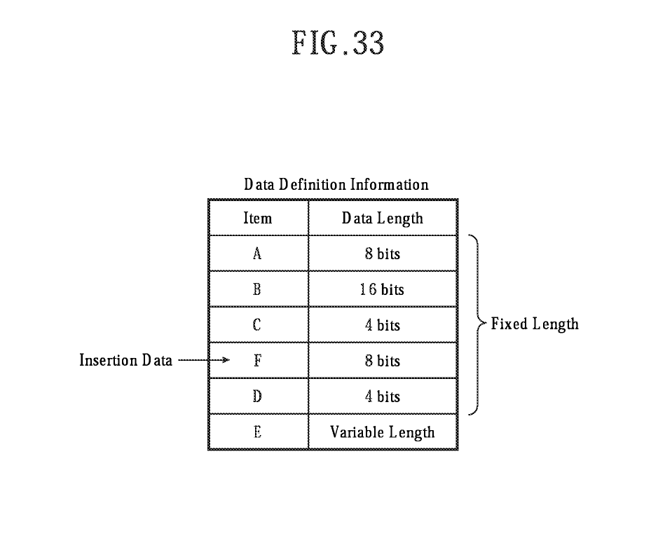

FIG. 33 is a table showing an outline of the update processing of the data definition information in accordance with the update definition information in FIG. 32. As described above, as for the map data corresponding to the updated map DB 10f, it is found in FIG. 33 that the update definition information shown in FIG. 32 causes update in such a manner that the item F with the data length of 8 bits is inserted following the item C of the map data corresponding to the map DB 10d.

Thus, the data definition information update unit 17a reads the existing data definition information corresponding to the map data, and updates it to the data definition information indicating the data structure in which the data of the item F with the data length of 8 bits is inserted next to the item C.

After that, the data definition information input unit 2 acquires the updated data definition information (step ST43). The data definition information acquired by the data definition information input unit 2 is delivered from the data definition information input unit 2 to the data definition information analysis unit 3.

The data definition information analysis unit 3 analyzes the contents of the data definition information fed from the data definition information input unit 2 (step ST44). The data management data output unit 6 reads the data management data output definition information (step ST45).

Next, the data management data generating unit 4 decides on whether the map data whose structure is defined by the data definition information includes variable length data or not from the analysis result of the data definition information fed from the data definition information analysis unit 3 (step ST46). Unless the map data includes the variable length data (NO at step ST46), the data management data generating unit 4 determines offsets to individual items from fixed length data items and their data lengths in the map data, and generates the data management data in which the offsets are set. After that, the processing proceeds to step ST47.

On the other hand, if the data includes variable length data (YES at step ST46), the data management data generating unit 4 reads the real data of the map data from the updated map DB 10f to check the data size of the variable length data section (step ST48), and analyzes the data size of the variable length data section (step ST49). According to the analysis, the data management data generating unit 4 obtains the variable length data items and their data lengths in the map data, specifies the real data structure considering together with them the fixed length data items and their data lengths, and generates the data management data that sets the offset values to the individual items on the basis of the real data structure. After that, the processing proceeds to step ST47.

At step ST47, the data management data output unit 6 acquires the data management data the data management data generating unit 4 generates (the data management data corresponding to the updated map DB 10f), outputs the data management data corresponding to the definition contents of objects to be output by referring to the data management data output definition information and stores in the storage apparatus (external storage unit 10 or the like of FIG. 2).

As for the generating processing of the data access program in accordance with the data definition information after the update by the data access program generating unit 5 and data access program output unit 7 and as for the reflection processing of the update map by the map DB update unit 15b, they are the same as those of the foregoing embodiment 3.

As described above, according to the present embodiment 5, the data definition information update unit 17a updates the data definition information 10e in such a manner as to reflect the updated data structure in accordance with the update definition information indicating the changed contents in the updated map DB 10f from the map DB 10d. By thus doing, it can automatically generate the data definition information 10e corresponding to the updated map DB 10f.

In addition, according to the present embodiment 5, the data definition information analysis unit 3 analyzes, when the data definition information update unit 17a updates the data definition information, the contents of the data definition information after the update; the data management data generating unit 4 generates the data management data 10b that defines the storage locations of the real data in the updated map DB 10f from the data structure of the updated map DB 10f obtained by analyzing the data definition information after the update by the data definition information analysis unit 3; and the data access program generating unit 5 generates the data access program 10c that describes the access function to the real data whose data structure in the updated map DB 10f is specified by analyzing the data definition information after the update by the data definition information analysis unit 3. In this way, when the data definition information is updated to the data definition information 10e corresponding to the updated map DB 10f, the data management data 10b and data access program 10c are automatically updated accordingly. As a result, it can access the map data efficiently and quickly even if the map DB is updated dynamically.

### Embodiment 6

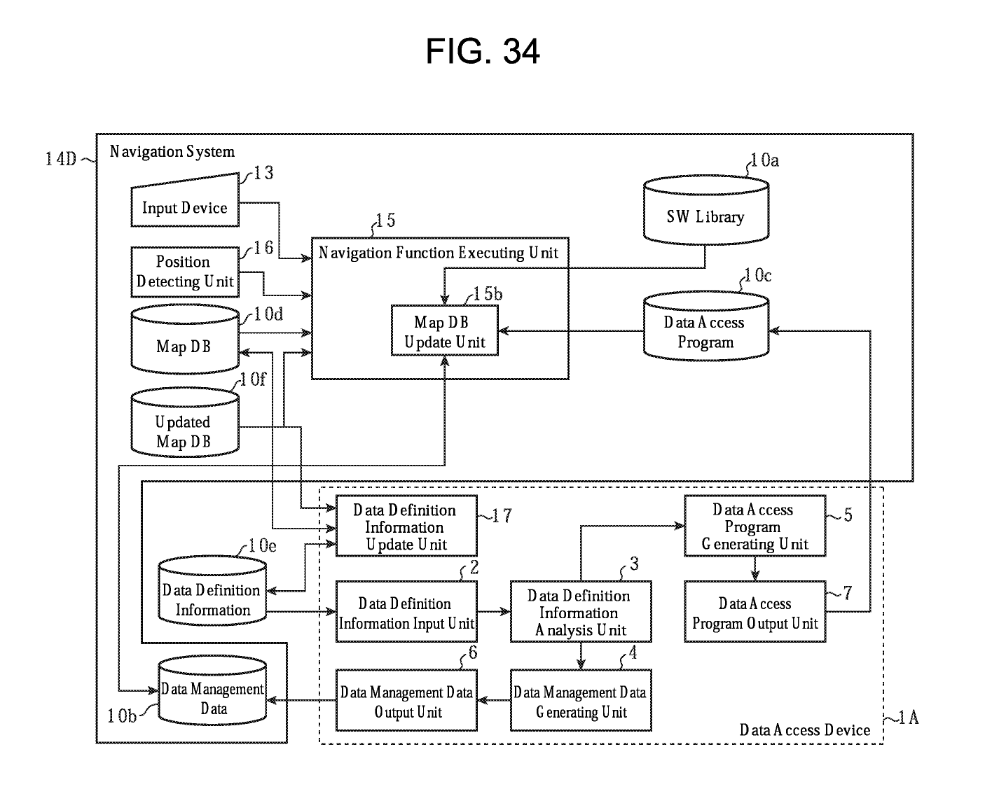

FIG. 34 is a block diagram showing a configuration of a navigation system of an embodiment 6 in accordance with the present invention. In FIG. 34, the navigation system 14D of the embodiment 6 has a configuration that separates from the configuration of the foregoing embodiment 4 the data definition information input unit 2, data definition information analysis unit 3, data management data generating unit 4, data access program generating unit 5, data management data output unit 6, data access program output unit 7 and data definition information update unit 17 as a data access device 1A. In the configuration, the navigation system 14D incorporates the data management data 10b and data access program 10c which are generated or updated by the data access device 1A.

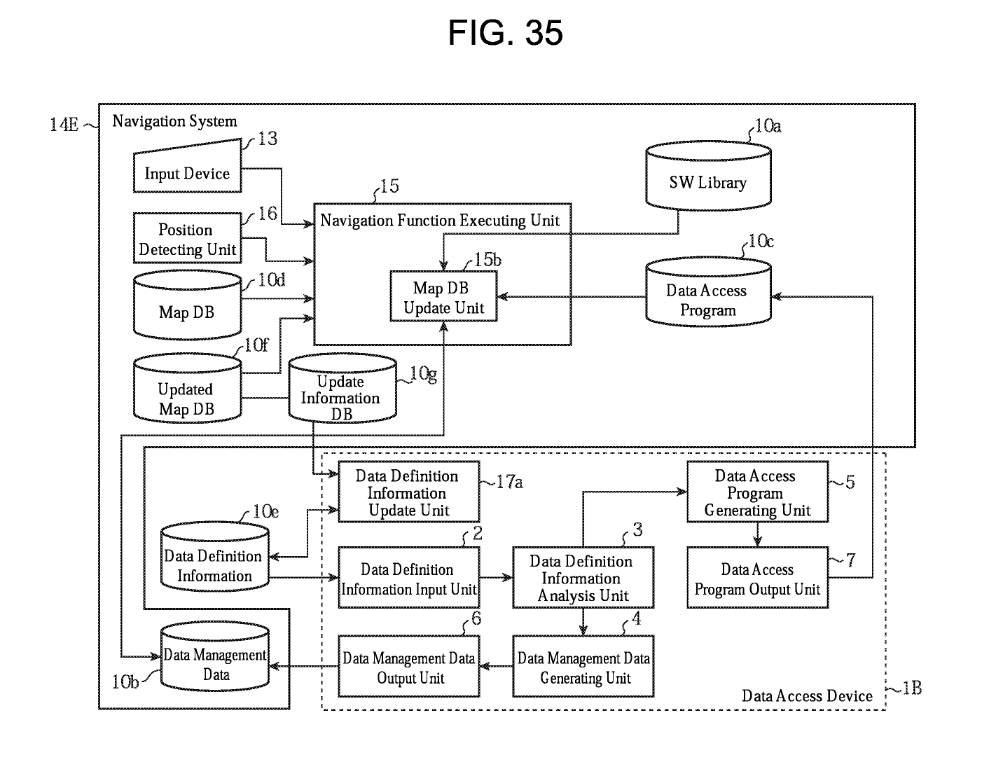

In addition, FIG. 35 is a block diagram showing another configuration of the navigation system of the embodiment 6. In FIG. 35, the navigation system 14E has a configuration that separates from the configuration of the foregoing embodiment 5 the data definition information input unit 2, data definition information analysis unit 3, data management data generating unit 4, data access program generating unit 5, data management data output unit 6, data access program output unit 7 and data definition information update unit 17a as the data access device 1B. In the configuration, the navigation system 14E incorporates the data management data 10b and data access program 10c which are generated or updated by the data access device 1B.

As described above, according to the present embodiment 6, it has the configuration as shown in FIG. 34 or FIG. 35, thereby being able to achieve the same advantages as the foregoing embodiments 3 and 4.

Incidentally, although the foregoing embodiments 3-6 show examples in which the data management data and map DB are provided as separate data, the data management data and map DB can be set as integrated data as shown in FIG. 25.

For example, a configuration is also possible which is able to gain access to desired map data more efficiently and quickly as compared with the case where they are set as separate data by providing the data management data for each mesh of the map data, and by determining the storage location in the map DB of the data necessary for the processing of each mesh by referring to the data management data corresponding to the mesh.

### INDUSTRIAL APPLICABILITY

A data access method in accordance with the present invention can gain access to the real data efficiently and quickly. Accordingly, it is suitable for an onboard navigation system and the like that requires quick navigation processing.

1. A data access method of an information processing apparatus that executes prescribed information processing by using real data acquired from a data group storing the real data, wherein
the information processing apparatus generates and stores in advance:
data management data that determines storage locations of the real data in the data group in accordance with data definition information indicating a data structure of the data group and data output definition information defining contents to be output; and
a data access program that describes an access function to the real data whose data structure in the data group is specified in accordance with the data definition information and the data output definition information, and wherein
the data access program gains access to the real data of the data group while determining the storage locations of the real data by referring to the data management data.

2. The data access method according to claim 1, wherein
the data management data and the data access program are managed separately from the group data.

3. A data access device comprising:
an input unit for acquiring data definition information indicating a data structure of a data group retaining real data;
an analysis unit for analyzing contents of the data definition information acquired by the input unit;
a data generating unit for generating data management data that defines storage locations of the real data in the data group from the data structure of the data group obtained by analyzing the data definition information by the analysis unit;
a program generating unit for generating a data access program that describes an access function to the real data whose data structure in the data group is specified while referring to the data management data generated by analyzing the data definition information by the analysis unit;
a data output unit for producing, by referring to data output definition information that defines contents to be output in the data management data, second data management data that satisfies the contents to be output from the data management data generated by the data generating unit; and
a program output unit for producing, by referring to program output definition information that defines contents to be output in the data access program, a second data access program that satisfies the contents to be output from the data access program generated by the program generating unit.
